(19) United States
(12) Patent Application Publication
(10) Pub. No.: US 2021/0406410 A1
(43) Pub. Date: Dec. 30, 2021

(54) METHOD AND DEVICE TO ENSURE A SECURE MEMORY ACCESS

(71) Applicant: Micron Technology, Inc., Boise, ID (US)

(72) Inventors: Antonino Mondello, Messina (IT); Alberto Troia, Munich (DE); Olivier Duval, Pacifica, CA (US); Zoltan Szubbocsev, Santa Clara, CA (US)

(21) Appl. No.: 16/624,940

(22) PCT Filed: Dec. 21, 2018
(86) PCT No.: PCT/IB2018/001463

§ 371 Date: Dec. 20, 2019

(51) Int. Cl. G06F 21/79; G06F 3/06; G06F 21/64; H04L 9/32; G06F 21/60

(52) U.S. Cl. CPC G06F 21/79; G06F 3/0622; G06F 3/0659; G06F 21/602; G06F 21/64; H04L 9/3242; G06F 3/0673

(57) ABSTRACT

The present disclosure relates to a system, a method and to a memory device to ensure a secure memory access to a memory device. The memory device is structured and organized with:

a first accessible data storage area configured to store data of a host device;

a second accessible data storage area configured to store metadata.

The second accessible data storage area is organized in groups of sub-fields including at least a first group of flags and at least another field of the same second accessible storage area selectable by the value of one of said flags.

### TECHNICAL FIELD

The present disclosure relates generally to apparatus, systems and methods related to memory devices, and more particularly, to ensure a secure memory access.

### BACKGROUND

Data and metadata are normally used in the technology of memory devices. Even if the parameters trimming is normally performed in fab at end of processing and before shipping, the security of the data stored in the metadata portion of the memory device may become a critical point.

In secure systems, it is desirable to have a memory device for which the contents may be verified as being correct. This may be particularly important when the memory device contains executable code potentially subject to damage or compromise. If the content of the memory device cannot be verified as correct, it may be possible to compromise the security of the system by modifying the code contained in it in an unauthorized manner. Moreover, this may even compromise the safety of the system, since it could use not correct data for the execution phase. This drawback may imply for instance unwanted jumps in unwanted portions of the code, for instance in the automotive field a steering system can run the code to turn left instead of the right after a command to turn right just because of an unwanted jump due to a data corruption.

All the types of memories must implement a controlled access to data stored.

In this respect, read operation can be free, but the users need to have a mechanism to validate data read in terms of integrity and/or authenticity of the source.

As to write operation, only the authorized user can be able to modify data, the memory component (RAM, FLASH, PCM) or the memory system (HDD, SSD) since the write operation can also include a modification of a component configuration register (i.e.: data protection registers, channel calibration, etc.).

Some types of memories like RAMs do not have a command set devoted for read and write operations (like flash memories), but they are controlled by a simple command set. In such cases it is important to define a mechanism for securing access of data (both in read/write phases) without using a complex command protocol structure.

As previously mentioned, this need is particularly felt in the automotive field and market wherein the security and safety of data and metadata is a must for autonomous or partially autonomous vehicles.

### BRIEF DESCRIPTION OF THE DRAWINGS

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which:

FIG. 1 is an example of a block diagram of a memory device realized according to one embodiment of the present technology and wherein a method of the present disclosure may be implemented;

FIG. 2 illustrates a block diagram of a portion of the memory device of the present disclosure wherein a data organization according to the present disclosure is implemented;

FIG. 3 illustrates a further block diagram of a metadata portion of the memory portion of FIG. 2 in accordance with the present disclosure;

FIG. 4 illustrates a known timing diagram for a memory portion, for instance the memory portion shown in FIG. 1, on which a known read access method is applied;

FIG. 5 illustrates a known timing diagram for a memory portion, for instance the memory portion shown in FIG. 1, on which a known write access method is applied;

FIG. 6 illustrates a block diagram of a portion of the memory device of the present disclosure wherein a data organization according to the present disclosure is implemented and wherein predetermined flag values are applied;

FIG. 7 illustrates a block diagram of a portion of the memory device of the present disclosure wherein a data organization according to the present disclosure is implemented and wherein further predetermined flag values are applied;

FIG. 8 illustrates a block diagram of a portion of the memory device of the present disclosure wherein a data organization according to the present disclosure is implemented and wherein flag values are applied to ensure a secure memory access.

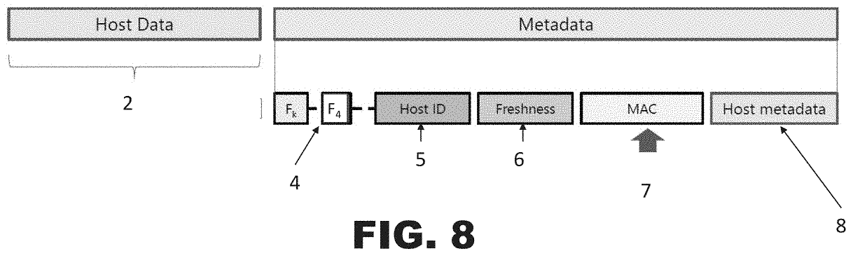

### DETAILED DESCRIPTION

As it will be described in greater details hereinafter, the technology disclosed herein relates to memory devices as well as to systems including memory devices. Moreover, the technology involving the present invention relates also to methods for implementing a secure access for the writing and/or reading phases to the above-mentioned memory devices.

As an example, the memory devices involved by the technology or the invention herewith disclosed may be a DRAM device even if this indication should not be considered a limitation of the Applicant's rights since the invention may be implemented on other memory devices such as RAMs.

A first embodiment of the present disclosure relates to a memory device for ensuring a secure memory access, comprising:
a first accessible data storage area configured to store data;
a second accessible data storage area configured to store metadata;
said second accessible data storage area being organized in groups of sub-fields or memory blocks including at least a first group of flags and at least another field of the same second accessible storage area selectable by the value of one of said flags.

The above mentioned one of said flags is a pointer or an enabling value to activate said at least another field. In some embodiments, the additional metadata content is used to enable certain security feature for the specific page containing the host data.

The first accessible data storage area is a host data portion containing the data that a host device of the memory device needs to store. While the second accessible data storage area is a metadata portion including in separate fields or memory blocks a group of flags, an ID field of a host device, an anti-replay mechanism and a cryptographic algorithm.

Moreover, among the sub-fields of the second accessible data storage area there is an anti-replay mechanism selectable by the value of one of said flags and including a monotonic counter or a Nonce or a TimeStamp or similar anti-replay mechanism.

Another embodiment of the present disclosure relates to method to ensure a secure memory access to a memory device, comprising:
organizing the memory device with a first accessible data storage area configured to store data;
organizing a second accessible data storage area configured to store metadata;
organizing said second accessible data storage area in groups of sub-fields including at least a first group of flags and at least another field of the same second accessible storage area selectable by the value of one of said flags.

It should be noted that the memory access of both memory portions is done by pages intended in the context of the present disclosure as the atomic minimal data that can be modified in the memory device.

Moreover, at least one of the sub-fields of said second accessible data storage area is the result of the application of a cryptographic algorithm to verify both the data integrity or the authentication of a message.

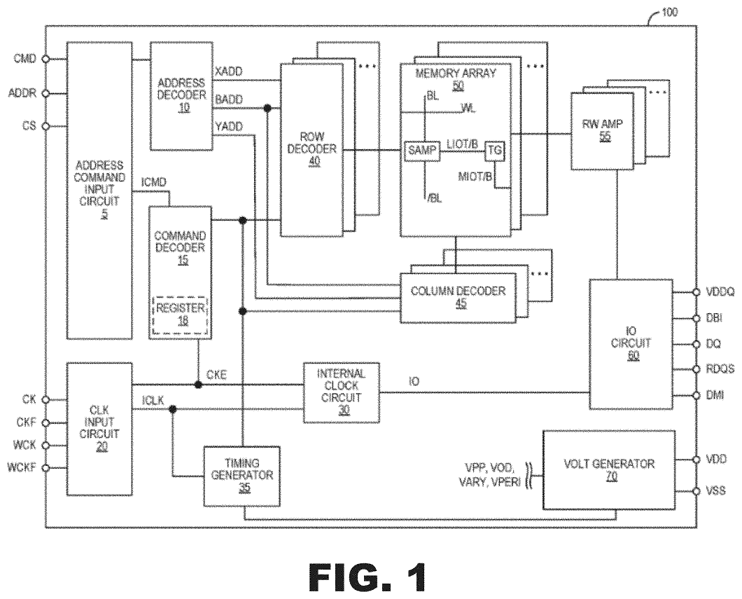

For a better understanding of the technology to which the invention is applied we will first disclose the main architecture of a semiconductor memory device shown schematically in the enclosed FIG. 1.

Making now reference to such a FIG. 1, it may be appreciated the presence of a main block diagram showing schematically a memory device 100 wherein at least one embodiment of the present invention may be implemented.

This memory device 100 is a schematic 2D representation of a semiconductor device that may be considered a volatile or a non-volatile memory such as NAND and/or NOR components; however, in more general sense the block diagram of FIG. 1 may be applicable for instance even to a dynamic random access memory of the DRAM type or, as an alternative, a SDRAM memory or a ROM device.

The memory device 100 can be connected to any one of a number of electronic devices capable of utilizing the memory for temporary or persistent storage of information, or a component of such a memory. For example, a host device of the memory device 100 may be a computing device such as a desktop or portable computer, a server, a hand-held device (e.g., a mobile phone, a tablet, a digital reader, a digital media player), or some component thereof (e.g., a central processing unit, a co-processor, a dedicated memory controller, etc.).

The host device may even be a networking device (e.g., a switch, a router, etc.) or a recorder of digital images, audio and/or video, a vehicle, an appliance, a toy, or any one of a number of other products. In one embodiment, the host device may be connected directly to memory device 100, although in other embodiments, the host device may be indirectly connected to memory device (e.g., over a networked connection or through intermediary devices).

For completeness sake and for a better understanding of the technology to which the invention is applied we will first disclose the main architecture of a semiconductor memory device 100 shown in FIG. 1.

The memory device 100 may include an array of storage cells. This array is indicated in FIG. 1 with the numeral 50 but it should be considered that the array is structured with a plurality of memory banks, for instance sixteen banks. Each memory bank may be considered a memory page. An array could be a two dimension matrix or also a 3D array of cells. What is important is just the possibility to identify pages of cells inside blocks; each page can be of 4 kbits or more depending on the used technology.

Each bank is substantially a memory matrix including thousands of memory cells. A simple cell of the matrix may be structured to store logic values in a volatile and non-volatile manner for instance like the cells of a RAM structure or the cells of a ROM structure. However, memory cells can include any one of a number of different memory media types such as, for instance, capacitive, magnetoresistive, ferroelectric, phase change, or the like.

In each array 50 the long horizontal lines connecting each row of the memory matrix are known as word lines (WL) while the column of cells of the memory matrix are known as bit lines (BL). Each memory cell may be identified at the intersection of a word line WL and a bit line BL. Word Lines and Bit Lines may also be referred to as Access Lines and/or Data Lines, respectively and as Access Lines interchangeably.

More specifically, each column of cell may include a pair of bit lines bl_t and bl_c that are connected to a sense amplifier SAMP. A sense amplifier SAMP is generally provided for each bit line pair BL. A sense amplifier may generally include a pair of cross-connected inverters between the pair of bit lines bl_t and bl_c.

The selection of a word line WL may be performed by a row decoder 40. Similarly, the selection of a bit line may be performed by a column decoder 45.

Sense amplifiers SAMP may be provided for each corresponding pair of bit lines bl_t and bl_c and connected to at least one respective local I/O line pair (LIOT/B) which may in turn be coupled to at least respective one main I/O line pair (MIOT/B) via transfer gates TG. Those gates TG may operate as switches.

The memory array 50 may include plate lines and corresponding circuitry for managing their operation but this is not so relevant for the purpose of the present invention.

A plurality of external terminals is associated to the memory device 100. These terminals include command and address terminals coupled to a command bus or an address bus to receive command signals CMD and address signals ADDR, respectively. The command and address terminals may be supplied with address signals and memory bank address signals from outside. Those address signals supplied to the address terminals are then transferred to an address decoder 10 via a command/address input circuit 5.

A command signal may also be generated as an internal command signal ICMD to a command decoder 15 via said command/address input circuit 5. In such a case various internal command signals may be generated for performing memory operations. The command/address input circuit 5 may include a register 18 to store and track various count values generated during refresh operations of the memory array 50.

The internal command signal ICMD may include activation commands to generate for instance a clocked command CK.

The address decoder 10 is coupled to both the row decoder 40 and to the column decoder 45. The address decoder 10 can supply a decoded row address signal (XADD) to the row decoder 40 as well as a decoded column address signal (YADD) to the column decoder 45. The address decoder 10 can also receive a bank address signal (BADD) to supply to both the row decoder 40 and column decoder 45.

It should be noted that the memory device 100 may include also a chip select terminal to receive a chip select signal CS and clock terminals to receive clock signals CK and CKF.

The command signals CMD, the address signals ADD and the chip select signal CS may be supplied to the memory device by a conventional memory controller not shown in the drawings.

When an active CS signal is provided to the memory device 100 then the command and address signals may be decoded and memory operation may be performed.

Other terminals are visible in FIG. 1 and may be grouped in: data clock terminals to receive data clock signals WCK and WCKF, data terminals DQ, RDQS, DBI and DMI, power terminals VDD, VSS, VDDQ, VSSQ. The data terminals and the power terminal VDDQ are coupled to an input/output circuit 60.

The clock terminals and data clock terminals may be supplied with external clock signals and complementary external clock signals. The external clock signals CK, CKF, WCK, WCKF can be supplied to a clock input circuit 20. The CK and CKF signals can be complementary, and the WCK and WCKF signals can also be complementary. Complementary clock signals can have opposite clock levels and transition between the opposite clock levels at the same time.

The clock input circuit 20 can receive the external clock signals to generate internal clock signals ICLK. The internal clock signals ICLK can be supplied to an internal clock circuit 30. The internal clock circuit 30 can provide various phase and frequency controlled internal clock signal based on the received internal clock signals ICLK and a clock enable signal CKE from the command/address input circuit 5.

With respect to the clock signals it must be noted that the memory array 50 can exchange data with other devices or circuits through the DQ data terminals. The data exchange requires an access time that is amount of time needed to get stable output after a change in address and may depend from another time parameter such as the column-to-column delay tCCD that is the minimum amount of time between column operations.

To complete the description of the memory device 100 it must be remarked that the power supply terminals may be supplied with power supply potentials VDD and VSS that can be supplied to an internal voltage generator 70 capable in turn to generate various internal potential indicated in FIG. 1 as VPP, VOD, VARY, VPERI. Those potentials value may be used in the row decoder 40 in the memory array 50 or in other circuit blocks.

The power supply terminals may also be supplied with power supply potential VDDQ that can be supplied to the input/output circuit 60 together with the power supply potential VSS to reduce power supply noise. The power supply potential VDDQ can be the same potential as the power supply potential VDD or can be a different potential.

When a read command is issued and a row address and a column address are timely supplied with the read command, read data can be read from memory cells in the memory array 50 designated by these row address and column address. The read command may be received by the command decoder 15, which can provide internal commands to input/output circuit 60 so that read data can be output from the data terminals DQ, RDQS, DBI, and DMI via read/write amplifiers 55 and the input/output circuit 60 according to the RDQS clock signals.

The read data may be provided at a time defined by a predetermined read latency information RL that can be programmed in the memory array 50. The read latency information RL can be defined in terms of clock cycles of the CK clock signal. For example, the read latency information RL can be a number of clock cycles of the CK signal after the read command is received by the memory array 50 when the associated read data is provided.

When a write command is issued and a row address and a column address are timely supplied with the command, write data can be supplied to the data terminals DQ, DBI, and DMI according to the WCK and WCKF clock signals. The write command may be received by the command decoder 15, which can provide internal commands to the input/output circuit 60 so that the write data can be received by data receivers in the input/output circuit 60 and supplied via the input/output circuit 60 and the read/write amplifiers 55 to the memory array 50. The write data may be written in the memory cell designated by the row address and the column address. The write data may be provided to the data terminals at a time that is defined by write latency WL information. The write latency WL information can be programmed in the memory device 100.

The write latency WL information can be defined in terms of clock cycles of the CK clock signal. For example, the write latency information WL can be a number of clock cycles of the CK signal after the write command is received by the memory device 100 when the associated write data is received.

For the purpose of the present disclosure it's not relevant how long the column access time can be. For instance, if two clock signals 2CK are required to complete a column access, we may consider that for these memory devices there is a coincidence between the time tCCD and two clock cycles: tCCD=2CK.

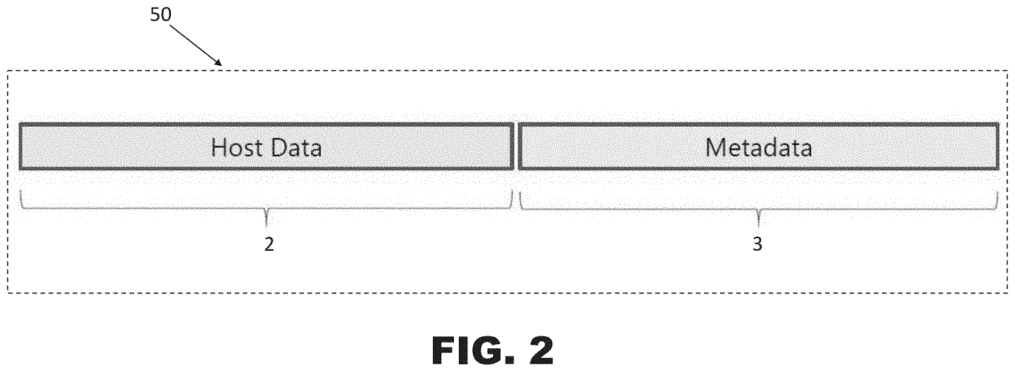

FIG. 2 shows an example of a logic organization of the memory device 100, and in particular of the memory array 50, wherein a first data portion 2 is defined, namely a host data portion that may be considered a field containing the data that a host devise needs to store.

Another data portion 3 of the memory array 50, namely a metadata portion, may be considered a field containing the user metadata and/or all other fields useful to manage the method of the present invention. For completeness sake it should be noted that a portion of the metadata may also be not visible externally to the user.

As it is well known, the principal purpose of metadata is to help users to find relevant information and discover resources. Metadata can also help the internal logic to store specific information as erase counter, so to apply wear leveling algorithm, and in general healthy data indicating the status of the pages/blocks. Metadata also helps to organize electronic resources, provide digital identification, and support the archiving and preservation of resources. Metadata assists users in resource discovery by allowing resources to be found by relevant criteria, identifying resources, bringing similar resources together, distinguishing dissimilar resources, and giving location information.

In some embodiments, according to the present invention the data access may be done by pages. With the term “page” it is intended a multiple of data that may be the minimum amount of data that can be read at the same time. For instance, the memory may be structured with 4 Kbyte pages, 8 Kbyte, 16 Kbyte pages and/or other sizes depending by the architecture of the device.

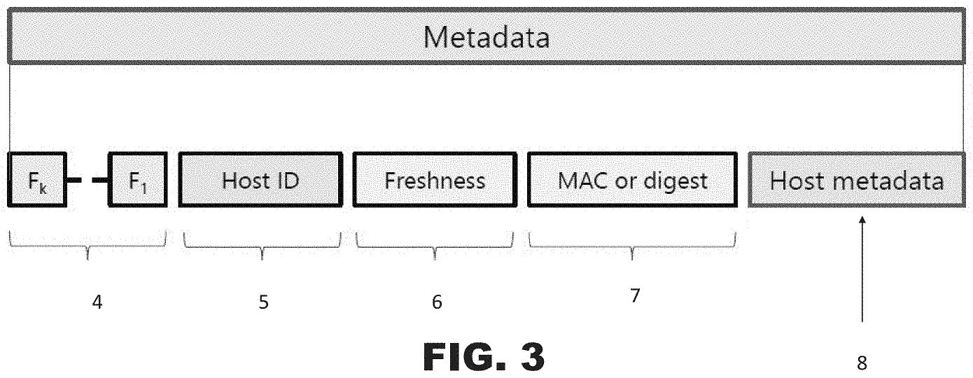

As a further example of data organization in accordance with the present disclosure, FIG. 3 shows a schematic view of the metadata portion 3 of the memory array 50 including sub-fields that will be detailed hereinafter.

A first group 4 of flags Fk, . . . , F1 include one or more flags that are provided to manage different services offered by the metadata portion 3 of the memory array 50.

A block 5 labelled Host ID has been provided to identify the ID of a software program or the application (APP) requesting an access to the metadata portion 3.

Another block 6 labelled “Freshness” refers to an anti-replay mechanism selectable by the value of the flags of the flags block 5. In other words, this block 6 includes at least one of the following functions: a monotonic counter as well as a Nonce or a TimeStamp or similar anti-replay mechanisms.

An anti-replay mechanism may be considered a sub-protocol of the Internet Engineering Task Force (IETF). An Anti-reply mechanism is a method to avoid to anyone to re-use the command/sequence/data stream where it is applied. For example, if the page content is signed using a monotonic counter value increasing its value at any read event, the signature will be different all the time; the signature variation due to the freshness implies that the data can be considered valid only in that specific read event.

The main goal of an anti-replay mechanism is that of avoiding man-in-the-middle attacks and usage of the stream multiple time and in multiple platforms. In other words, the main goal of an anti-replay is to avoid hackers injecting or making changes in data packets that travel from a source to a destination.

The anti-reply field is visible to anyone, as it can be for the data. However, the usage of this value in the calculation of the signature makes the signature unique to that read/write event. The Anti-replay protocol may use a unidirectional security association in order to establish a secure connection between two nodes in a network. Once a secure connection is established, the anti-replay protocol uses packet sequence numbers to defeat replay attacks.

A further block 7 may be considered a field including an indication for using a digest or MAC algorithm for the stored data. The usage of the digest or MAC is defined by the value of one of the flags of the first block. MAC or HASH are known generic cryptographic algorithms. For example, a known HASH algorithm may be any cryptographic primitive, such as SHA256, MD5, SHA3. Similarly, a known MAC algorithm may be any cryptographic primitive, such as the HMAC-SHA256.

Just for clarity, in cryptography an HMAC (sometimes expanded as either keyed-hash message authentication code or hash-based message authentication code) is a specific type of message authentication code (MAC) involving a cryptographic hash function and a secret cryptographic key. It may be used to simultaneously verify both the data integrity and the authentication of a message, as with any MAC. Any cryptographic hash function, such as SHA256 or SHA-3, may be used in the calculation of an HMAC; the resulting MAC algorithm is termed HMAC-X, where X is the hash function used (e.g. HMAC-SHA256 or HMAC-SHA3).

The block 7 may include a digest or MAC of the data stored:

MAC_value=MAC (Secret Key, HOST_DATA|Metadata)

DIGEST_value=HASH (HOST_DATA|Metadata)

The presence of one of the above field depend on content of the F1, Fk flags.

Just to provide a simple example with a two flags case wherein the parameter K is set to 1: K=1, we would obtain:

00→Legacy

01→MAC service→authentication

10→HASH service→integrity, attestation

11→internal (component)→ECC service

Finally, the block 8 represents host metadata that are present in managed memories. In other words, differently from the present disclosure, the host metadata portion 8 may be considered the sole metadata memory portion that is present in the known solutions in association with the host data portion.

In the present disclosure the host metadata can include also application of host data, or better user metadata; for instance, an example of user metadata may be identified in a NAND device where the ECC value to correct the page is stored in a portion of this metadata area.

The logic organization of the memory array 50 according to the present disclosure allows implementing a unified secure access of data/configuration for different components like NAND, FLASH, RAM etc . . .

For instance, the data may be written with the legacy protocol of the component (FLASH/RAM etc . . . ).

If one of the flags F1, . . . , Fk of the flags block 4 in the metadata portion 3 is set in a suitable manner, the corresponding component is selected to provide the service requested.

For instance, if no specific request is done, defined by the term “nothing”, then at least a regular legacy approach is performed by default:

Nothing→Legacy

In other words, the absence of the assertion of the flags implies that the component is a legacy component; for instance, a DRAM is a legacy DRAM, a NAND a legacy NAND, etc. mainly because the other metatada values do not care as per the first block set.

As an alternative, when a MAC or HASH cryptographic primitive is demanded, then a cryptographic function is applied, even if the flag may be reset in case of need. Therefore, the corresponding flags should (1) enable the usage of the cryptography algorithm, (2) define if the value expected is a DIGEST or a MAC.

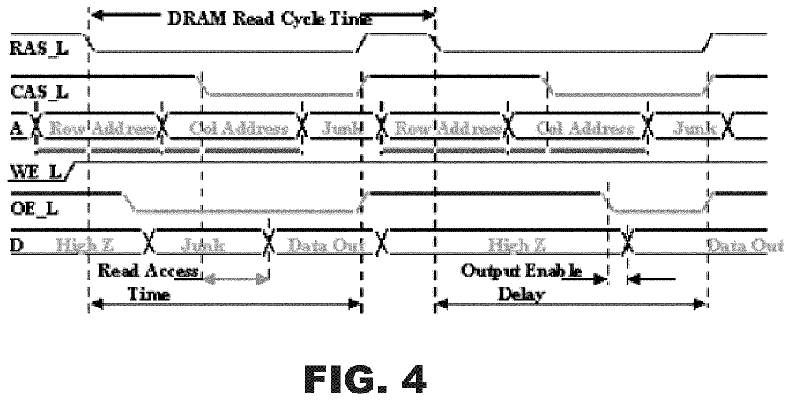

Making quick reference to the example of the FIGS. 3 and 4, it may be appreciated that the diagram of the various signals involved in a DRAM read cycle is dependent on the logic value of OE_L signal. In an early read cycle the OE_L signal is asserted before the CAS_L signal while in a late read cycle the OE_L signal is asserted after the CAS_L signal.

Similarly, in FIG. 4 it is reported the diagram of the various signals involved in a DRAM write cycle and it may be appreciated that in an early write cycle the WE_L signal is asserted before the CAS_L signal while in a late write cycle the WE_L signal is asserted after the CAS_L signal.

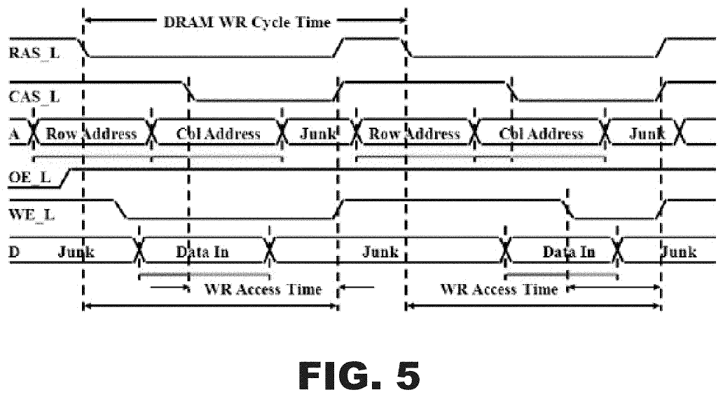

FIG. 4 and FIG. 5 represent timing diagrams of a legacy access in a DRAM component, the first example is a read access sequence while the other example is the write access sequence. Legacy is the term usually used to intend standard component without deviation to standards, as Jedec.

If we concentrate our attention of the example of FIG. 5, we may appreciate how the data organization of the present disclosure allows performing a memory access during the writing phase with a request for a digest service and according to very simple rules. As previously said, FIG. 5 shows schematically a timing diagram of a legacy write phase in a DRAM component. The legacy command are used in the present invention as a method to send the additional metadata to the pages so that, when the program operation is done, the special page of the component will be done providing: page content plus Metadata content.

The data are written according to the legacy protocol of the component (FLASH/RAM etc . . . ). At least one of the flags (F1 or F2) is set to request the digest or MAC service.

A conventional approach may be defined, for instance when F2 is set to “0” (F2=0) then the DIGEST_value is provided by the host, while when F2 is set to “1” (F2=1) then the DIGEST_value is calculated by the component.

In this content, there is a great benefit given by the fact that after reading data the host is ensured about the data integrity.

As usual, the host data portion 2 contains the data that the host needs to store.

One of flags of the flags block 4, in the example the second flag F2, is set to request the digest service while the other fields Host ID 5 and Freshness 6 may include information that are optionally sent by the host device or software application.

According to the value of the flag F2 the digest service is performed, for instance: DIGEST_value=HASH (HOST_DATA|Metadata).

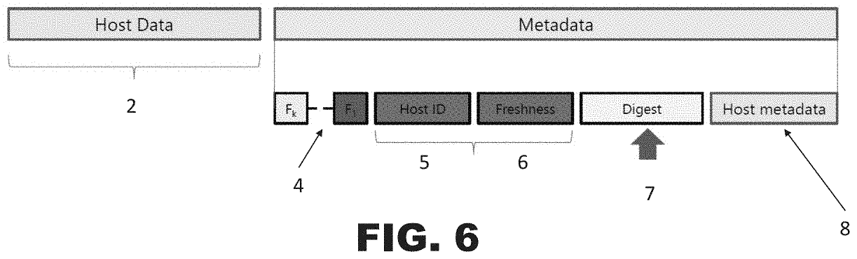

Making now reference to the example schematically shown in FIG. 6, we may appreciate the different approach that is applied when an authentication service is requested during a data write access.

As in the previous example, the data are written with the legacy protocol of the component (FLASH/RAM etc . . . ).

In this case the flag F3 is set to request the authentications service. The MAC value is provided by the host device or software application according to the value of the F2 flag.

Therefore, according to the value of the flag F3 the authentication service is performed, for instance: MAC_value=MAC (Secret Key, HOST_DATA|Metadata).

In this specific example we obtain not only a data integrity but also an authentication of the data.

This means that the data write access phase is allowed if and only if the authentication is verified. The write operation is performed internally to the component if the authentication phase is positive meaning that the resulting value is pass.

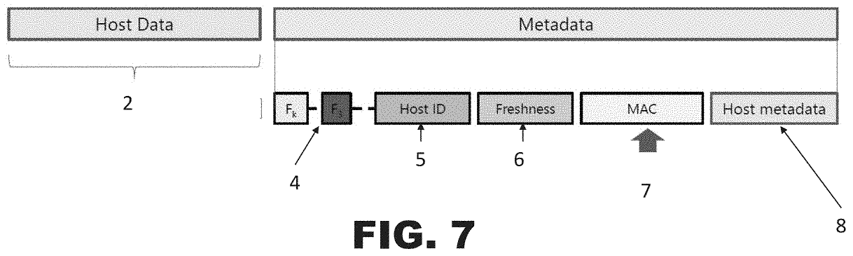

A further and more complex example may be followed making reference to FIG. 7 wherein the same memory organization of the previous examples is presented with the only difference that further flags, for instance F4 and/or F5, are involved in the selection of the requested services.

The memory device receives as usual the data to be written and even in this case the host data portion 2 contains the data that the host needs to store.

The metadata portion 3 is involved to check the value of freshness block 6 allowing to select one of the possible anti-reply mechanisms to be used to avoid a non-authorized double access to the data. The selection of the alternative mechanism in the Freshness block 6 are implemented for instance by the flags F4 and/or F5.

For instance, by setting to “0” both values of the flags F4, F5 it may be selected a monotonic counter mechanism allowing to check if the MTC value is greater than the previous one.

As an alternative, by setting to “1” only one of the two flags F4, F5, it may be selected a check about the time stamp value. Obviously, the flags association to the functionalities must be considered as a non-limiting example since the meaning can vary either in position and real meaning.

As a further alternative, always acting on the logic value of the flags F4, F5, it may be selected a check about the NONCE value (i.e.: a pseudo number . . . ). A nonce value is an arbitrary number used only once in a cryptographic communication, in the spirit of a nonce word. They are often random or pseudo-random numbers.

Many nonce values also include a TimeStamp to ensure exact timeliness, though this requires clock synchronization between organizations. For instance, the addition of a client nonce (“cnonce”) helps to improve the security in some ways as implemented in digest access authentication.

To ensure that a nonce is used only once, it should be time-variant (including a suitably fine-grained TimeStamp in its value), or generated with enough random bits to ensure a probabilistically insignificant chance of repeating a previously generated value.

According to the present invention, the metadata portion 3 may also be involved in calculating and checking the matching of the provided MAC value. However, the local calculus must be performed with the secret key of the HOST-ID block 5.

If all the checks are positive the user is authenticated and the record is updated accordingly thus obtaining data integrity and source authentication.

The above examples are disclosed with reference to the write access phase to the memory array 50 of the memory device 100.

As far as the read access phase is concerned, the data are read with the legacy default protocol of the component (FLASH, DRAM, SRAM etc . . . )

If one of the flags of the flags block 4 of the metadata portion 3 is set in an appropriate manner, the HOST ID block 5 performs the required checks.

In this situation, having set a “0” value means having to apply at least a legacy protocol.

The authentication service is performed according to the block content: MAC or HASH or etc. Once a flag is set, it can be reset with the few restrictions previously explained.

The host device accepts or discards data if a problem is intercepted: for instance, data may be discarded if one of the following situations should be detected:

Digest wrong→data corrupted

MAC wrong→data corrupted or not authentic etc . . .

ECC service→correct data by using eventual user metadata stored for that purpose.

The advantage is that of obtaining a secure component configuration.

As a matter of fact the methodology presented in the present disclosure may be used to change component register (i.e. the component configuration).

For instance, the inventive memory managing method of the present disclosure allows implementing a unified secure access of data/configuration for different components, that is to say for different memory devices.

More particularly, it is possible to change the component register and obtain a secure component configuration, for instance:

A Channel calibration drives to an Output Drive Strength

A memory parameter change drives to secure component configuration.

The methodology can be used also to lock the memory registers and configurations, so only authenticated and/or secure commands can modify how the device is set to operate. This implies the impossibility to change configuration values, as output drive strength, etc. without being recognized as the owner of the application/software.

All these interventions are performed in a secure way. For instance, the secure register are mapped and managed with MAC option and only a super-user, that is to say: an authorized user, can change them.

As an alternative, the configuration integrity is ensured by the digest block 7.

All in all the method disclosed in this specification allows implementing a unified and secure access of data and/or configuration for different memory components or devices such as NAND, FLASH, RAMs or DRAMs.

At the same time it is possible to ensure integrity of data and authenticity of the source also for memory components without a command set,

In conclusion it is possible to configure the memory device or component in a secure way with the further possibility to assure the configuration integrity.

In the preceding detailed description, reference is made to the accompanying drawings that form a part hereof, and in which is shown, by way of illustration, specific examples. Similar elements or components between different figures may be identified by the use of similar digits. As will be appreciated, elements shown in the various embodiments herein can be added, exchanged, and/or eliminated so as to provide a number of additional embodiments of the present disclosure.

In addition, as will be appreciated, the proportion and the relative scale of the elements provided in the figures are intended to illustrate the embodiments of the present disclosure and should not be taken in a limiting sense.

As used herein, “a number of” something can refer to one or more of such things. A “plurality” of something intends two or more. As used herein, the term “coupled” may include electrically coupled, directly coupled, and/or directly connected with no intervening elements (e.g., by direct physical contact) or indirectly coupled and/or connected with intervening elements. The term coupled may further include two or more elements that co-operate or interact with each other (e.g., as in a cause and effect relationship).

Although specific examples have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. The scope of one or more examples of the present disclosure should be determined with reference to the appended claims, along with the full range of equivalents to which such claims are entitled.

The above description is intended to be illustrative, and not restrictive. For example, the above-described configurations (or one or more aspects thereof) may be used in combination with others. Other configurations may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as configurations may feature a subset of said features. Further, configurations may include fewer features than those disclosed in a particular configuration. Thus, the following claims are hereby incorporated into the Detailed Description, with a claim standing on its own as a separate configuration. The scope of the configurations disclosed herein is to be determined with reference to the appended claims, along with the full scope of equivalents to which such claims are entitled.

1-30. (canceled)

31. A memory device for ensuring a secure memory access, comprising:
a first accessible data storage area configured to store data;
a second accessible data storage area configured to store metadata;
the second accessible data storage area being organized in groups of sub-fields including at least a first group of flags and at least another field of the same second accessible storage area selectable by the value of one of the first group of flags.

32. The memory device of claim 31 wherein at least one of the first group of flags comprises a pointer or an enabling value to activate the at least another field.

33. The memory device of claim 31 wherein the first accessible data storage area comprises a host data portion containing data that a host device of the memory device needs to store.

34. The memory device of claim 31 wherein the memory access of both memory portions is done by pages.

35. The memory device of claim 31 wherein one of the sub-fields of the second accessible data storage area comprises a cryptographic algorithm to verify either the data integrity or the authentication of a message.

36. The memory device of claim 35 wherein the cryptographic algorithm includes a digest or a message authentication code (MAC) involving a cryptographic hash function and a secret cryptographic key.

37. The memory device of claim 36 wherein a MAC algorithm includes at least a cryptographic primitive including a HASH function.

38. The memory device of claim 31 wherein the second accessible data storage area comprises a metadata portion including in separate fields: a group of flags, an ID field of a host device, an anti-replay mechanism and a cryptographic algorithm.

39. The memory device of claim 38 wherein the ID field of a host device has been provided to identify the ID of a software application requesting an access to the metadata portion.

40. The memory device of claim 31 wherein at least one of the sub-fields of the second accessible data storage area comprises an anti-replay mechanism selectable by the value of one of the first group of flags.

41. The memory device of claim 40, wherein the selectable anti-replay mechanism includes at least one of the following functions: a monotonic counter or a Nonce or a Time Stamp.

42. A method to ensure a secure memory access to a memory device, comprising:
organizing the memory device with a first accessible data storage area configured to store data;
organizing the memory device with a second accessible data storage area configured to store metadata;
organizing the second accessible data storage area in groups of sub-fields including at least a first group of flags and at least another field of the same second accessible storage area selectable by the value of one of the first group of flags.

43. The method of claim 42, further comprising including a host data portion containing data that a host device of the memory device needs to store within the first accessible data storage area.

44. The method of claim 42, further comprising including an anti-replay mechanism selectable by the value of one of the first group flags within at least one of the sub-fields of the second accessible data storage area.

45. The method of claim 42, further comprising including a cryptographic algorithm to verify either the data integrity or the authentication of a message within one of the sub-fields of the second accessible data storage area.

46. The method of claim 42, further comprising including a metadata portion having in separate fields: a group of flags, an ID field of a host device, an anti-replay mechanism and a cryptographic algorithm within the second accessible data storage area.

47. An electronic system, comprising:
a host device; and
a memory device coupled to the host device and comprising:
a first accessible data storage area configured to store data of the host device; and
a second accessible data storage area configured to store metadata;
wherein the second accessible data storage area is organized in groups of sub-fields or memory blocks including at least a first group of flags and at least another field selectable by the value of one of the flags.

48. The system of claim 47 wherein the at least one of the flags comprises at least one of:
a pointer; or
an enabling value to activate the at least another field.

49. The system of claim 47 wherein at least one of the sub-fields of the second accessible data storage area comprises a cryptographic algorithm to verify either the data integrity or the authentication of a message.

50. The system of claim 47 wherein the host device is connected directly to the memory device or is coupled to the memory device through intermediary devices.
